(19) United States
(12) Patent Application Publication
(10) Pub. No.: US 2022/0368951 A1
(43) Pub. Date: Nov. 17, 2022

(54) Method and Apparatus of Separated Coding Tree Coding with Constraints on Minimum CU Size

(71) Applicant: HFI Innovation Inc., Zhubei City, Hsinchu County (TW)

(72) Inventors: Tzu-Der CHUANG, Hsinchu City (TW); Ching-Yeh CHEN, Hsinchu City (TW); Chih-Wei HSU, Hsinchu City (TW); Yu-Wen HUANG, Hsinchu City (TW)

(21) Appl. No.: 17/762,967

(22) PCT Filed: Sep. 23, 2020
(86) PCT No.: PCT/CN2020/117046

§ 371 Date: Mar. 23, 2022

Related U.S. Application Data
(60) Provisional application No. 62/914,576, filed on Oct. 14, 2019.
(60) Provisional application No. 62/911,946, filed on Oct. 7, 2019.
(60) Provisional application No. 62/905,588, filed on Sep. 25, 2019.
(60) Provisional application No. 62/904,851, filed on Sep. 24, 2019.

(51) Int. Cl. H04N 19/96; H04N 19/186; H04N 19/169; H04N 19/176; H04N 19/70

(52) U.S. Cl. CPC H04N 19/96; H04N 19/186; H04N 19/1883; H04N 19/176; H04N 19/70

(57) ABSTRACT

A method and apparatus for block partition in video encoding and decoding are disclosed. According to one method of the present invention, input data associated with a current block in a current picture are received, wherein the current block comprises a luma block and a chroma block to be encoded or decoded, and wherein a minimum block size is constrained to be no greater than a constrained minimum size for the luma block regardless of whether a dual partition tree or a single partition tree is used for the current block. The luma block is partitioned into one or more luma leaf blocks and the chroma block into one or more chroma leaf blocks using the dual partition tree or the single partition tree. Said one or more luma leaf blocks and said one or more chroma leaf blocks are encoded or decoded.

### CROSS REFERENCE TO RELATED APPLICATIONS

The present invention claims priority to U.S. Provisional Patent Application, Ser. 62/904,851, filed on Sep. 24, 2019, U.S. Provisional Patent Application, Ser. No. 62/905,588, filed on Sep. 25, 2019, U.S. Provisional Patent Application, Ser. No. 62/911,946, filed on Oct. 7, 2019 and U.S. Provisional Patent Application, Ser. No. 62/914,576, filed on Oct. 14, 2019. The U.S. Provisional Patent Applications are hereby incorporated by reference in their entireties.

### FIELD OF THE INVENTION

The present invention relates to block partition of luma and chroma blocks using separate partition trees in video coding. In particular, the present invention discloses schemes to manage constraints on minimum CU size when separate partition trees are allowed.

### BACKGROUND AND RELATED ART

The High Efficiency Video Coding (HEVC) standard is developed under the joint video project of the ITU-T Video Coding Experts Group (VCEG) and the ISO/IEC Moving Picture Experts Group (MPEG) standardization organizations, and is especially with partnership known as the Joint Collaborative Team on Video Coding (JCT-VC). In HEVC, one slice is partitioned into multiple coding tree units (CTU). In main profile, the minimum and the maximum sizes of CTU are specified by the syntax elements in the sequence parameter set (SPS). The allowed CTU size can be 8×8, 16×16, 32×32, or 64×64. For each slice, the CTUs within the slice are processed according to a raster scan order.

The CTU is further partitioned into multiple coding units (CU) to adapt to various local characteristics. A quadtree, denoted as the coding tree, is used to partition the CTU into multiple CUs. Let CTU size be M×M, where M is one of the values of 64, 32, or 16. The CTU can be a single CU (i.e., no splitting) or can be split into four smaller units of equal sizes (i.e., M/2×M/2 each), which correspond to the nodes of the coding tree. If units are leaf nodes of the coding tree, the units become CUs. Otherwise, the quadtree splitting process can be iterated until the size for a node reaches a minimum allowed CU size as specified in the SPS (Sequence Parameter Set). This representation results in a recursive structure as specified by a coding tree (also referred to as a partition tree structure).

In the emerging video coding standard (names VVC, Versatile Video Coding), flexible CU structure such as Quad-Tree-Binary-Tree (QTBT) (H. Huang, et al., “EE2.1: Quadtree plus binary tree structure integration with JEM tools,” Joint Video Exploration Team (JVET) of ITU-T SG 16 WP 3 and ISO/IEC JTC 1/SC 29/WG 11, 3rd Meeting: Geneva, CH, 26 May-1 Jun. 2016, Document: JVET-C0024) shows good coding performance compared to Quad-Tree (QT) structure in HEVC. In QTBT, as shown in FIG. 1, a Coding Tree Unit (CTU) is firstly partitioned by a quad-tree structure. The quad-tree leaf nodes are further partitioned by a binary-tree structure. After constructing the binary tree structure, binary-tree leaf nodes are denoted as Coding Units (CUs), which are used for prediction and transform without any further partitioning. FIG. 1 illustrates an example of block partitioning 110 and its corresponding QTBT 120. The solid lines indicate quadtree splitting and dotted lines indicate binary tree splitting. In each splitting node (i.e., non-leaf node) of the binary tree, one flag indicates which splitting type (horizontal or vertical) is used, 0 may indicate horizontal splitting and 1 may indicate vertical splitting.

In addition to quad-tree (210) and horizontal (H) and vertical (V) binary-tree (BT) (220 and 230), horizontal (H) and vertical (V) ternary-tree (TT) partitioning (240 and 250) is employed to capture objects in the center of blocks, as shown in FIG. 2. A CTU is firstly partitioned by quad-tree. The quad-tree leaf nodes are further partitioned by a sub-tree which contains both binary and ternary partitions (partitions 220 to 250 in FIG. 2). After constructing the sub-tree structure, sub-tree leaf nodes are denoted as Coding Units (CUs), which are used for prediction and transform without any further partitioning.

In VVC Draft 6 (B. Bross, et al., “Versatile Video Coding (Draft 6)”, Joint Video Exploration Team (JVET) of ITU-T SG 16 WP 3 and ISO/IEC JTC 1/SC 29/WG 11, 15th Meeting: Gothenburg, SE, 3-12 Jul. 2019, Document: JVET-02001), the dual tree coding can be applied in I-slice or I-picture. When the dual tree is applied, a CTU with size larger than 64×64 will be inferred to be partitioned into 64×64 blocks (in luma samples). For each 64×64 block, the dual tree coding is applied. Within this 64×64 region, the luma component and chroma component can have different coding tree structure.

### BRIEF SUMMARY OF THE INVENTION

A method and apparatus for block partition in video encoding and decoding are disclosed. According to one method of the present invention, input data associated with a current block in a current picture are received, wherein the current block comprises a luma block and a chroma block to be encoded or decoded, and wherein a minimum block size is constrained to be no greater than a constrained minimum size for the luma block. The luma block is partitioned into one or more luma leaf blocks and the chroma block into one or more chroma leaf blocks using the dual partition tree or the single partition tree. Said one or more luma leaf blocks and said one or more chroma leaf blocks are encoded or decoded.

In one embodiment, the constrained minimum size is equal to 64.

In one embodiment, the minimum block size is indicated by a syntax in a video bitstream comprising coded data of the current picture. The syntax may represent a value related to log-base-2 of the minimum block size according to one embodiment. The syntax can be signalled in SPS (sequence parameter set) level of the video bitstream according to one embodiment.

In one embodiment, the minimum block size is constrained to be no greater than the constrained minimum size for the luma block in both conditions corresponding to the dual partition tree being selected for the current block and the single partition tree being selected for the current block.

### BRIEF DESCRIPTION OF THE DRAWINGS

FIG. 1 illustrates an example of block partitioning and its corresponding quad-tree plus binary tree structure (QTBT), where the solid lines indicate quadtree splitting and dotted lines indicate binary tree splitting.

FIG. 2 illustrates an example of feasible splitting types for block partition according to flexible partition.

FIG. 3 illustrates a flowchart of an exemplary coding system with a constrained minimum block size when the dual tree partition is enabled according to an embodiment of the present invention.

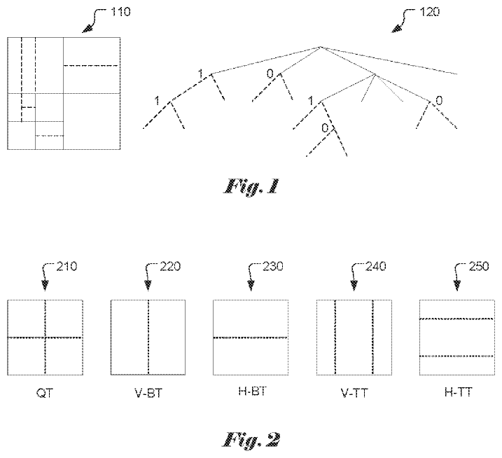

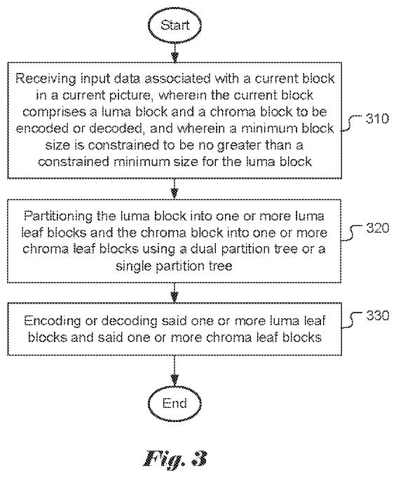

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

In VVC-draft 6, variable MinCbSizeY is derived to indicate the minimum CU size of this picture or sequence. The variable is derived according to:
MinCbSizeY=1<MinCbLog2SizeY,
where the MinCbLog2SizeY is derived by:
MinCbLog2SizeY=log 2_min_luma_coding_block_size_minus2+2.

MinCbLog2SizeY represents the log-base-2 of minimum luma block size. In the above equation, operator “<<” means left-shift operation. In other words, “1<<x” is equivalent to 2^{x} . The syntax log 2_min_luma_coding_block_size_minus2 is signalled in the sequence parameter set (SPS). However, if MinCbSizeY is set to 128, which indicates that the minimum CU size shall be 128×128. On the other hand, when qtbtt_dual_tree_intra_flag is true and slice type is equal to I (i.e., the dual tree being applied), the current 128×128 block will be inferred to be divided into 64×64 blocks. The CU size starts from 64×64, which violates the condition that the minimum CU size shall be 128×128 and is contradictory to the MinCbSizeY setting. To support such large CU, several methods are proposed.

### Method 1: Disabling Dual Tree when MinCbSizeY is Larger than 64

In VVC Draft 6, syntax qtbtt_dual_tree_intra_flag is signalled in SPS. Syntax log 2_min_luma_coding_block_size_minus2 is also signalled in the SPS, but after syntax qtbtt_dual_tree_intra_flag. According to one embodiment, syntax qtbtt_dual_tree_intra_flag syntax is signalled after syntax log 2_min_luma_coding_block_size_minus2. Furthermore, when log 2_min_luma_coding_block_size_minus2 is 5 (which means MinCbSizeY is equal to 128), or is equal to or larger than 5 (which means MinCbSizeY is equal to or larger than 128), syntax qtbtt_dual_tree_intra_flag is not signalled and inferred as 0. In another example, the encoder constraint can be applied. It is a bitstream conformance requirement that when log 2_min_luma_coding_block_size_minus2 is larger than or equal to 5, qtbtt_dual_tree_intra_flag shall be 0.

In another embodiment, qtbtt_dual_tree_intra_flag can be signalled. However, the dual tree will be disabled when MinCbSizeY is equal to 128, or is equal to or larger than 128. For example, the syntax modification can be as follow Table 1, where the single tree coding structure can be used in this situation.

TABLE 1

| | Descrip- |
|---|---|
| | tor |
| coding_tree_unit( ) { | |
| ... | |
| if( slice_type = = I && qtbtt_dual_tree_intra_flag && | Note 1 |
| MinCbSizeY <= | |
| 64 ) | |
| dual_tree_implicit_qt_split ( xCtb, yCtb, CtbSizeY, 0 ) | |
| else | |
| coding_tree( xCtb, yCtb, CtbSizeY, CtbSizeY, 1, 1, 0, | |
| 0, 0, 0, 0, | |
| SINGLE_TREE, MODE_TYPE_ALL ) | |
| } | |

In the above syntax design, a condition “&& MinCbSizeY <=64” is added to the “if statement” as indicated by Note 1.

In another embodiment, the syntax qtbtt_dual_tree_intra_flag is signalled outside SPS. For example, qtbtt_dual_tree_intra_flag can be signalled in PPS (picture parameter set), slice, tile, brick, tile-group, APS (adaptation parameter set), or VPS (video parameter set) level header. When log 2_min_luma_coding_block_size_minus2 is 5, or is equal to or larger than 5 (which means MinCbSizeY is equal to 128, or is equal to or larger than 128), the syntax qtbtt_dual_tree_intra_flag is not signalled and inferred as 0.

In one embodiment, syntax log 2_min_luma_coding_block_size_minus2 can also be signalled in PPS, slice, tile, brick, tile-group, APS, or VPS-level header as well.

In another embodiment, variable qtbtt_dual_tree_intra_enable can be derived in PPS, slice, tile, brick, tile-group, APS, or VPS-level. If MinCbSizeY is equal to or larger than 64, qtbtt_dual_tree_intra_enable is set to 0. The syntax modification can be as follow Table 2.

TABLE 2

| | De- |
|---|---|
| | scrip- |
| | tor |
| coding_tree_unit( ) { | |
| ... | |
| if( slice_type = = I && qtbtt_dual_tree_intra_enable ) | Note 2 |
| dual_tree_implicit_qt_split ( xCtb, yCtb, CtbSizeY, 0 ) | |
| else | |
| coding_tree( xCtb, yCtb, CtbSizeY, CtbSizeY, 1, 1, 0, | |
| 0, 0, | |
| 0, 0, | |
| SINGLE_TREE, MODE_TYPE_ALL ) | |
| } | |

In the above syntax design, a condition “&& qtbtt_dual_tree_intra_enable” is added to the “if statement” as indicated by Note 2.

The specific values of 5, 64, 6, and 128 mentioned above are intended to illustrate examples according to embodiments of the present invention and these values can be replaced by other values.

### Method 2: MinCbSizeY is Constrained to be No Greater than 64 when the Dual Tree is Enabled

In this method, MinCbSizeY is constrained to be smaller than or equal to 64 when the dual tree is applied. In one embodiment, log 2_min_luma_coding_block_size_minus2 shall be smaller than 5 when qtbtt_dual_tree_intra_flag is true. For example, it is a bitstream conformance requirement that when qtbtt_dual_tree_intra_flag is 1. In this case, the value of log 2_min_luma_coding_block_size_minus2 shall not be larger than or equal to 5. In another embodiment, log 2_min_luma_coding_block_size_minus2 is clipped to be smaller than 5 or the MinCbLog2SizeY is clipped to be smaller than 7 when qtbtt_dual_tree_intra_flag is true.

In another embodiment, MinCbLog2SizeY shall be smaller than 5 or MinCbSizeY shall not be larger than 64 when qtbtt_dual_tree_intra_flag is true or when the dual tree is applied. MinCbLog2SizeY can be determined according to MaxCbLog2SizeY.

In one embodiment, log 2_min_luma_coding_block_size_minus2 can also be signalled in PPS, slice, tile, brick, tile-group, APS, or VPS-level header.

In another embodiment, MinCbSizeYSlice or MinCbSizeYTile can be derived or signalled/parsed for each slice, each tile or in a certain level. When the dual tree is enabled, the signalled or derived MinCbSizeYSlice or MinCbSizeYTile shall not be larger than 64. For example, MinCbSizeY can be 128 as indicated in SPS; but in the I-slice with the dual tree enabled, MinCbSizeYSlice is clipped to 64; and while in the Inter-slice, the MinCbSizeYSlice can be 128.

### Method 3: MinCbSizeY Shall Not Be Larger Than 64

According to this method, MinCbSizeY is constrained to be smaller than or equal to 64 regardless of whether the dual tree is applied or not. In one embodiment, log 2_min_luma_coding_block_size_minus2 shall be smaller than 5. For example, it is a bitstream conformance requirement that the value of log 2_min_luma_coding_block_size_minus2 shall not be larger than or equal to 5. For another example, the value range of log 2_min_luma_coding_block_size_minus2 shall be in the range of 0 to 4. In another embodiment, log 2_min_luma_coding_block_size_minus2 is clipped to be smaller than 5 or the MinCbLog2SizeY is clipped to be smaller than 7.

In another embodiment, MinCbLog2SizeY shall be smaller than 5 or MinCbSizeY shall not be larger than 64. MinCbLog2SizeY can be determined according to MaxCbLog2SizeY.

In one embodiment, log 2_min_luma_coding_block_size_minus2 can also be signalled in PPS, slice, tile, brick, tile-group, APS, or VPS-level header.

In another embodiment, MinCbSizeYSlice or MinCbSizeYTile can be derived or signalled/parsed for each slice, each tile or in a certain level. The signalled or derived MinCbSizeYSlice or MinCbSizeYTile shall not be larger than 64.

The value of MinCbSizeYSlice or MinCbSizeYTile above 64 can be replaced by other predefined values. The value can be the supported transform block size. For example, in VVC, the maximum supported transform block size is 64.

### Method-4: Using the Single Tree or Leaf CU when the Dual Tree is Enabled and MinCbSizeY is Larger than 64

According to this method, when the dual tree is enabled and MinCbSizeY is larger than 64, the leaf CU can be directly applied. The syntax modification can be as follow Table 3. The QP information can be reset as well.

TABLE 3

| | De- |
|---|---|
| | scrip- |
| | tor |
| coding_tree_unit( ) { | |
| ... | |
| if( slice_type = = I && qtbtt_dual_tree_intra_flag){ | |
| if(MinCbSizeY <= 64) | Note 3 |
| dual_tree_implicit_qt_split ( xCtb, yCtb, CtbSizeY, 0 ) | |
| else { | Note 4 |
| if( cu_qp_delta_enabled_flag && qgOnY && | |
| cbSubdiv <= cu_qp_delta_subdiv ) { | |
| IsCuQpDeltaCoded = 0 | |
| CuQpDeltaVal = 0 | |
| CuQgTopLeftX = x0 | |
| CuQgTopLeftY = y0 | |
| } | |
| if( cu_chroma_qp_offset_enabled_flag && qgOnC && | |
| cbSubdiv <= cu_chroma_qp_offset_subdiv ) | |
| IsCuChromaQpOffsetCoded = 0 | |
| coding unit( xCtb, yCtb, CtbSizeY, | |
| CtbSizeY, 0, SINGLE_TREE, MODE_TYPE_ALL) | |
| } | Note 5 |
| } | |
| else | |
| coding_tree( xCtb, yCtb, CtbSizeY, CtbSizeY, 1, 1, 0, 0, | |
| 0, 0, 0, | |
| SINGLE_TREE, MODE_TYPE_ALL ) | |
| } | |

In the above syntax design, an additional test condition “if(MinCbSizeY <=64)” is added as indicated by Note 3. When the condition “if(MinCbSizeY <=64)” is not satisfied, additional statements are added as indicated from Note 4 to Note 5.

In another embodiment, qtbtt_dual_tree_intra_flag can be signalled. However, the dual tree will be disabled when MinCbSizeY is equal to 128, oris equal to or larger than 128. For example, the syntax modification can be as follow Table 4. The single tree coding structure can be used in this situation.

TABLE 4

| | De- |
|---|---|
| | scrip- |
| | tor |
| coding_tree_unit( ) { | |
| ... | |
| if( slice_type = = I && qtbtt_dual_tree_intra_flag && | Note 6 |
| MinCbSizeY | |
| <= 64 ) | |
| dual_tree_implicit_qt_split ( xCtb, yCtb, CtbSizeY, 0 ) | |
| else | |
| coding_tree( xCtb, yCtb, CtbSizeY, CtbSizeY, 1, 1, 0, 0, | |
| 0, 0, 0, | |
| SINGLE_TREE, MODE_TYPE_ALL ) | |
| } | |

In the above syntax design, a condition “&& MinCbSizeY <=64” is added to the “if statement” as indicated by Note 6. An alternative syntax design is shown as follow Table 5.

TABLE 5

| | Descrip- |
|---|---|
| | tor |
| coding_tree_unit( ) { | |
| ... | |
| if( slice_type = = I && qtbtt_dual_tree_intra_flag && | Note 7 |
| !(MinCbSizeY > | |
| 64) ) | |
| dual_tree_implicit_qt_split ( xCtb, yCtb, CtbSizeY, 0 ) | |
| else | |
| coding_tree( xCtb, yCtb, CtbSizeY, CtbSizeY, 1, 1, 0, | |
| 0, 0, 0, 0, | |
| SINGLE_TREE, MODE_TYPE_ALL ) | |
| } | |

In the above syntax design, a condition “&& MinCbSizeY <=64” is added to the “if statement” as indicated by Note 7. An alternative syntax design is shown as follows.

In another embodiment, when the dual tree is applied (i.e., qtbtt_dual_tree_intra_flag equal to 1), for an I-slice, it can only use QT-split when CU size is larger than 64×64 or CU width or height is larger than 64.

In another embodiment, when the dual tree is applied (i.e., qtbtt_dual_tree_intra_flag equal to 1), for an I-slice, it can only use QT-split or BT-split when CU size is larger than 64×64 or CU width or height is larger than 64. The TT is not allowed.

In another embodiment, when the dual tree is applied (qtbtt_dual_tree_intra_flag) and when MinCbSizeY is larger than 64, for an I-slice, it can only use QT-split when CU size is larger than 64×64 or CU width/height is larger than 64.

In another embodiment, when the dual tree is applied (qtbtt_dual_tree_intra_flag) and when MinCbSizeY is larger than 64, for an I-slice, it can only use QT-split or BT-split when CU size is larger than 64×64 or CU width/height is larger than 64. The TT is not allowed.

### Method 5: Signalling MinCbSizeYDualTree or MinCbSizeYI

In this method, when the dual tree is enabled, an additional syntax MinCbSizeYDualTree or MinCbSizeYI can be signalled. MinCbSizeYDualTree or MinCbSizeYI indicates the minimum CU size for I-slice or dual tree enabled slice. For example, log 2_min_luma_coding_block_size_in_I_slice_minus2 or log 2_min_luma_coding_block_size_dual_tree minus2 can be signalled. The value of log 2_min_luma_coding_block_size_in_I_slice_minus2 or log 2_min_luma_coding_block_size_dual_tree minus2 cannot be larger than 4 when the dual tree is enabled. In words, MinCbSizeYDualTree or MinCbSizeYI cannot be larger than 64 when the dual tree is enabled. For other slices, e.g. P/B-slice, the original MinCbSizeY is used.

### Method 6: MinCbSizeY is Constrained to be Larger than 64 or the Dual-Tree Start Split Size

According to this method, MinCbSizeY is constrained to be smaller than or equal to 64 or the dual-tree start split size regardless whether the dual tree is applied or not. For example, if the dual-tree is enabled, in dual_tree_implicit_qt_split function, the CU is inferred to be split by quad-tree partition to a predefined or signalled block size (e.g. using QT-split if the CU size, width, and/or height is larger than the predefined or signalled block size). Then, the dual-tree partition starts from this predefined or signalled block size. The luma and chroma can have different coding tree structure from this predefined or signalled block size. In VVC Draft 6, the size is 64 (e.g. 64×64 block). In this method, MinCbSizeY is constrained to be smaller than or equal the dual-tree start split size. In one embodiment, log 2_min_luma_coding_block_size_minus2 shall be smaller than 5 or log 2(dual-tree start split size)-2. For example, it is a bitstream conformance requirement that the value of log 2_min_luma_coding_block_size_minus2 shall not be larger than or equal to 5 or log 2(dual-tree start split size)-2. According to another embodiment, log 2_min_luma_coding_block_size_minus2 is clipped to be smaller than 5 or log 2(dual-tree start split size)-2, or MinCbLog2SizeY is clipped to be smaller than 7 or is clipped to be smaller than or equal to log 2(dual-tree start split size).

According to another embodiment, the MinCbLog2SizeY shall be smaller than 5 or log 2(dual-tree start split size)-2, or MinCbSizeY shall not be larger than 64 or dual-tree start split size. MinCbLog2SizeY can be determined according to MaxCbLog2SizeY.

According to one embodiment, log 2_min_luma_coding_block_size_minus2 can also be signalled in PPS, slice, tile, brick, tile-group, APS or VPS-level header.

According to another embodiment, MinCbSizeYSlice or MinCbSizeYTile can be derived or signalled/parsed for each slice, each tile or in a certain level. The signalled or derived MinCbSizeYSlice or MinCbSizeYTile shall not be larger than 64 or the dual-tree start split size.

The value of MinCbSizeYSlice or MinCbSizeYTile above 64 can be replaced by other predefined values, or the dual-tree start split size (e.g. the value used in dual_tree_implicit qt split, as indicated by Note 8 in the below syntax Table 6). The value can be the supported transform block size. For example, in VVC, the maximum supported transform block size is 64.

TABLE 6

| | Descriptor |
|---|---|
| dual_tree_implicit_qt_split( x0, y0, cbSize, cqtDepth ) { | |
| cbSubdiv = 2 * cqtDepth | |
| if( cbSize > 64 ) { | Note 8 |
| if( cu_qp_delta_enabled_flag && cbSubdiv <= cu_qp_delta_subdiv ) { | |
| IsCuQpDeltaCoded = 0 | |
| CuQpDeltaVal = 0 | |
| CuQgTopLeftX = x0 | |
| CuQgTopLeftY = y0 | |
| } | |
| if( cu_chroma_qp_offset_enabled_flag && | |
| cbSubdiv <= cu_chroma_qp_offset_subdiv ) | |
| IsCuChromaQpOffsetCoded = 0 | |
| x1 = x0 + ( cbSize / 2 ) | |
| y1 = y0 + ( cbSize / 2 ) | |
| dual_tree_implicit_qt_split( x0, y0, cbSize / 2, cqtDepth + 1 ) | |
| if( x1 < pic_width_in_luma_samples ) | |
| dual_tree_implicit_qt_split( x1, y0, cbSize / 2, cqtDepth + 1 ) | |
| if( y1 < pic_height_in_luma_samples ) | |
| dual_tree_implicit_qt_split( x0, y1, cbSize / 2, cqtDepth + 1 ) | |
| if( x1 < pic_width_in_luma_samples && y1 < | |
| pic_height_in_luma_samples ) | |
| dual_tree_implicit_qt_split( x1, y1, cbSize / 2, cqtDepth + 1 ) | |
| } else { | |
| coding_tree( x0, y0, cbSize, cbSize, 1, 0, cbSubdiv, cqtDepth, 0, 0, 0, | |
| DUAL_TREE_LUMA, MODE_TYPE_ALL ) | |
| coding_tree( x0, y0, cbSize, cbSize, 0, 1, cbSubdiv, cqtDepth, 0, 0, 0, | |
| DUAL_TREE_CHROMA, MODE_TYPE_ALL ) | |
| } | |
| } | |

Any of the foregoing proposed methods can be implemented in encoders and/or decoders. For example, any of the proposed methods can be implemented in an Inter, Intra, prediction, transform or block partition module of an encoder, and/or an inverse transform, Inter, Intra, prediction or block partition module of a decoder. Alternatively, any of the proposed methods can be implemented as a circuit coupled to the inverse transform, Inter, Intra, prediction or block partition module of the encoder and/or the inter/intra/prediction/transform module of the decoder, so as to provide the information needed by the Inter, Intra, prediction, transform or block partition module.

FIG. 3 illustrates a flowchart of an exemplary coding system with a constrained minimum block size when the dual tree partition is enabled according to an embodiment of the present invention. The steps shown in the flowchart, as well as other following flowcharts in this disclosure, may be implemented as program codes executable on one or more processors (e.g., one or more CPUs) at the encoder side and/or the decoder side. The steps shown in the flowchart may also be implemented based hardware such as one or more electronic devices or processors arranged to perform the steps in the flowchart. According to this method, input data associated with a current block in a current picture are received I step 310, wherein the current block comprises a luma block and a chroma block to be encoded or decoded, and wherein a minimum block size is constrained to be no greater than a constrained minimum size for the luma block. The luma block is partitioned into one or more luma leaf blocks and the chroma block into one or more chroma leaf blocks using a dual partition tree or a single partition tree in step 320. Said one or more luma leaf blocks and said one or more chroma leaf blocks are encoded or decoded in step 330.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding used by a video coding system, the method comprising:
receiving input data associated with a current block in a current picture, wherein the current block comprises a luma block and a chroma block to be encoded or decoded, and wherein a minimum block size is constrained to be no greater than a constrained minimum size for the luma block;
partitioning the luma block into one or more luma leaf blocks and the chroma block into one or more chroma leaf blocks using a dual partition tree or a single partition tree; and
encoding or decoding said one or more luma leaf blocks and said one or more chroma leaf blocks.

2. The method of claim 1, wherein the constrained minimum size is equal to 64.

3. The method of claim 1, wherein the minimum block size is indicated by a syntax in a video bitstream comprising coded data of the current picture.

4. The method of claim 3, wherein the syntax represents a value related to log-base-2 of the minimum block size.

5. The method of claim 3, wherein the syntax is signalled in SPS (sequence parameter set) level of the video bitstream.

6. The method of claim 1, wherein the minimum block size is constrained to be no greater than the constrained minimum size for the luma block in both conditions corresponding to the dual partition tree being selected for the current block and the single partition tree being selected for the current block.

7. An apparatus of video encoding and decoding used by a video encoding system and video decoding system respectively, the apparatus comprising one or more electronic circuits or processors arrange to:
receive input data associated with a current block in a current picture, wherein the current block comprises a luma block and a chroma block to be encoded or decoded, and wherein a minimum block size is constrained to be no greater than a constrained minimum size for the luma block;
partition the luma block into one or more luma leaf blocks and the chroma block into one or more chroma leaf blocks using a dual partition tree or a single partition tree; and
encode or decode said one or more luma leaf blocks and said one or more chroma leaf blocks.

8. The apparatus of claim 7, wherein the constrained minimum size is equal to 64.

9. The apparatus of claim 7, wherein the minimum block size is indicated by a syntax in a video bitstream comprising coded data of the current picture.

10. The apparatus of claim 9, wherein the syntax represents a value related to log-base-2 of the minimum block size.

11. The apparatus of claim 9, wherein the syntax is signalled in SPS (sequence parameter set) level of the video bitstream.

12. The apparatus of claim 7, wherein the minimum block size is constrained to be no greater than the constrained minimum size for the luma block in both conditions corresponding to the dual partition tree being selected for the current block and the single partition tree being selected for the current block.
